(19) United States
(12) Patent Application Publication
(10) Pub. No.: US 2025/0347776 A1
(43) Pub. Date: Nov. 13, 2025

(54) OBJECT RECOGNITION APPARATUS AND METHOD

(71) Applicant: HL KLEMOVE CORPORATION, Incheon (KR)

(72) Inventor: Jong-Wun SUL, Incheon (KR)

(21) Appl. No.: 18/919,885

(22) Filed: Oct. 18, 2024

(30) Foreign Application Priority Data
May 10, 2024 (KR) 10-2024-0061778

(51) Int. Cl. G01S 7/41; G01S 13/52; G01S 13/931

(52) U.S. Cl. CPC G01S 7/415; G01S 13/52; G01S 13/931; G01S 2013/932

(57) ABSTRACT

An object recognition apparatus and method. If a predetermined condition is satisfied based on position information detected by a position detection sensor and normal operation information of the position detection sensor, a determining section categorizes an object candidate as one of a specific object or a normal object based on first sensing information and, after a predetermined time, second sensing information received from a radar sensor.

### CROSS REFERENCE TO RELATED APPLICATION

This application claims priority from Korean Patent Application No. 10-2024-0061778, filed on May 10, 2024, which is hereby incorporated by reference for all purposes as if fully set forth herein.

### BACKGROUND

### Technical Field

Embodiments relate to an object recognition apparatus and method.

### Description of Related Art

Vehicles are increasingly equipped with advanced driver assistance systems (ADAS) to facilitate vehicle control. In particular, radar sensors capable of recognizing and categorizing various objects during driving are essential for ADAS systems. However, an object on the road (e.g., tunnel vents, signs, or overpasses) may be incorrectly reflected depending on the performance of radar sensors, thereby resulting in inaccurate elevation information of the objects and, as a result, such an object may be incorrectly detected as being in the path of a host vehicle. In particular, there is a risk that a tunnel vent may be misidentified as a moving object and therefore subject to ADAS control, due to the Doppler effect caused by the rotation of the tunnel vent.

However, the object recognition technology is not yet advanced enough to solve the problem of object misidentification by vehicle radar sensors.

### BRIEF SUMMARY

Embodiments may provide an object recognition apparatus that calculates distance errors using in-vehicle sensors and categorizes objects using the distance errors.

Embodiments may also provide an object recognition method that calculates distance errors using in-vehicle sensors and categorizes objects using the distance errors.

According to an aspect, embodiments may provide an object recognition apparatus of a vehicle, the object recognition apparatus including: a condition determining section determining whether a predetermined condition is satisfied based on position information detected by a position detection sensor and normal operation information of the position detection sensor; a receiver, if the predetermined condition is determined to be satisfied, receiving first sensing information and, after a predetermined time, second sensing information from a radar sensor; an estimator producing distance estimation information of an object candidate after the predetermined time based on the first sensing information; a calculator calculating distance difference information using distance information calculated for the object candidate based on the second sensing information and the distance estimation information; and a determining section categorizing the object candidate as one of a specific object or a normal object based on the distance difference information.

According to another aspect, embodiments may also provide an object recognition method including: determining whether a predetermined condition is satisfied based on position information detected from a position detection sensor and normal operation information of the position detection sensor; if the predetermined condition is determined to be satisfied, receiving first sensing information and, after a predetermined time, second sensing information from a radar sensor; producing distance estimation information after the predetermined time for an object candidate based on the first sensing information; calculating distance difference information using distance information calculated for the object candidate based on the second sensing information and the distance estimation information; and categorizing the object candidate as one of a specific object or a normal object based on the distance difference information.

According to another aspect, embodiments may also provide a vehicle controller including: at least one memory having computer program instructions stored therein; and at least one processor executing the computer program instructions. The at least one processor: receives first sensing information and, after a preset time period, second sensing information from a radar sensor; if a predetermined condition is satisfied based on position information detected from the position detection sensor and normal operation information of the position detection sensor, produces the distance estimation information after the predetermined time for an object candidate based on the first sensing information; calculates distance difference information using distance information calculated for the object candidate based on the second sensing information and the distance estimation information; and categorizes the object candidate as one of a specific object or a normal object based on the distance difference information.

According to embodiments, the object recognition apparatus and method calculate distance errors using in-vehicle sensors and categorize objects using the distance errors.

### BRIEF DESCRIPTION OF THE SEVERAL VIEWS OF THE DRAWINGS

The above and other objectives, features, and advantages of the present disclosure will be more clearly understood from the following detailed description, taken in conjunction with the accompanying drawings, in which:

FIG. 1 is a diagram illustrating an object recognition apparatus according to embodiments;

FIG. 2 is a flowchart illustrating the operation of determining whether a predetermined condition is satisfied according to embodiments;

FIGS. 3A and 3B are diagrams illustrating a distance estimation information factor according to embodiments;

FIGS. 4A to 4C are diagrams illustrating the operation of calculating distance difference information according to embodiments;

FIG. 5 is a diagram illustrating the operation of categorizing an object candidate according to embodiments; and

FIG. 6 is a flowchart illustrating an object recognition method according to embodiments.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to categorize the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after”, “subsequent to”, “next”, “before”, and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

An object recognition apparatus 100 according to embodiments may be an advanced driver assistance system (ADAS) mounted on a vehicle to provide information to assist in the operation of the vehicle or to assist a driver in controlling the vehicle.

As used herein, the ADAS may refer to various types of ADAS, and driver assistance systems may include, for example, autonomous emergency braking (AEB) systems, smart parking assistance systems (SPAS), blind spot detection (BSD) systems, adaptive cruise control (ACC) systems, lane departure warning systems (LDWS), lane keeping assist systems (LKAS), lane change assist systems (LCAS), and the like, but are not limited thereto.

In addition, the object recognition apparatus 100 may be applied to manned vehicles and autonomous vehicles in which a driver is in a vehicle to control the vehicle.

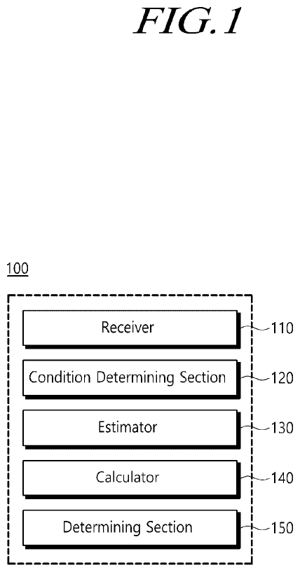

FIG. 1 is a diagram illustrating an object recognition apparatus according to embodiments.

Referring to FIG. 1, the object recognition apparatus 100 may include: a receiver 110 receiving first sensing information and, after a predetermined time, second sensing information from a radar sensor; a condition determining section 120 determining whether a predetermined condition is satisfied based on position information detected by a position detection sensor and normal operation information of the position detection sensor; an estimator 130, if the predetermined condition is determined to be satisfied, produces distance estimation information of an object candidate after the predetermined time based on the first sensing information; a calculator 140 calculating distance difference information using distance information calculated for the object candidate based on the second sensing information and the distance estimation information; and a determining section 150 categorizing the object candidate as one of a specific object or a normal object based on the distance difference information.

The receiver 110 may receive the first sensing information and, after the predetermined time, the second sensing information from the radar sensor.

For example, the radar sensor may include at least one of a front radar sensor mounted on a front portion of the vehicle, a rear radar sensor mounted on a rear portion of the vehicle, or a side or side-rear radar sensors mounted on each side of the vehicle.

In addition, the radar sensor of the present disclosure may include at least one transmitting antenna transmitting radar signals to the outside of the vehicle and at least one receiving antenna receiving reflected signals, which are radar signals reflected from one or more objects surrounding the vehicle.

In addition, the radar sensor of the present disclosure may be implemented as a frequency modulated continuous wave (FMCW) radar. However, this is illustrative only, and the present disclosure is not limited to any particular type of radar, as long as the principle of the disclosure is applicable. An FMCW radar transmits a linear frequency modulated signal and then detects the distance and speed of a target based on the frequency difference between the received reflected signal and the FMCW signal. If the radar sensor of the present disclosure is implemented as an FMCW radar, the general configuration and operation of the FMCW radar is known in the art, and specific description is omitted.

In another example, the receiver 110 may set in advance a definition for “after the predetermined time”.

In an example, the receiver 110 may set “after the predetermined time” to be after a time equal to a sensing period of the radar sensor (about 50 ms to 100 ms) has passed from a time point that the vehicle entered the tunnel.

In another example, “after the predetermined time” may be set in advance to be “X seconds later”, where X is a real number greater than or equal to zero. However, “after the predetermined time” is not limited this embodiment, and may be set variously in advance.

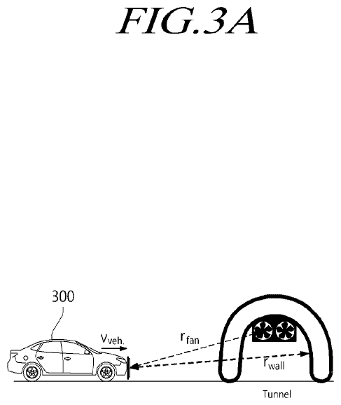

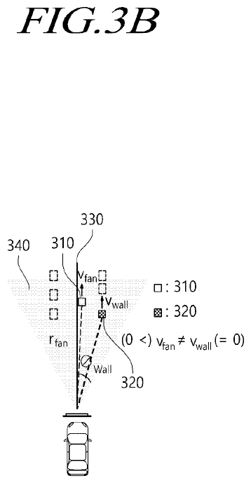

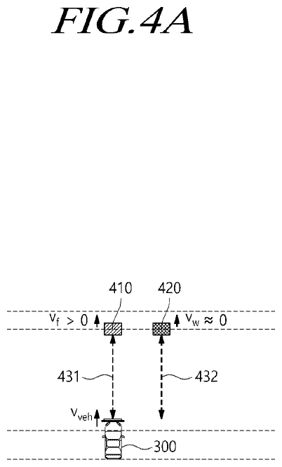

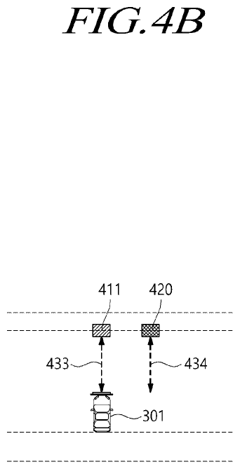

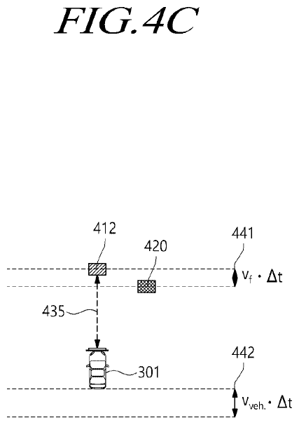

In another example, the first sensing information and the second sensing information may respectively include distance information, angle information, and speed information for the object candidate. The first sensing information and the second sensing information may respectively refer to information (e.g., distance information, angle information, and speed information) received from a sensing area of the radar sensor. The respective information included in the first sensing information and the second sensing information will be described later with reference to FIGS. 3A, 3B, and 4A to 4C.

The condition determining section 120 may determine whether the predetermined condition is satisfied based on the position information detected from the position detection sensor and the normal operation information of the position detection sensor.

For example, the position detection sensor may refer to a sensor mounted on a vehicle. In an example, the position detection sensor may refer to a global positioning system (GPS) device. In addition, the position detection sensor may detect the position information and the normal operation information.

In an example, the position information may include the current position of the vehicle in a case in which the vehicle is traveling. The position information may also include the position of a roadway, the position of a tunnel, the position of a structure in the tunnel (e.g., a tunnel vent or a tunnel wall), the position of a guardrail, the position of a sign, the position of an overpass, the position of a train crossing, and the like. However, the position information of this embodiment is not intended to be limiting, and the position information may include various position information.

In another example, the normal operation information may include information for determining whether the position detection sensor is functioning normally and information for determining whether the position detection sensor is malfunctioning.

However, the position detection sensor of this embodiment is not intended to be limiting, and the position detection sensor may be implemented as various position detection sensors, and may include various information.

In another example, the condition determining section 120 may set the predetermined condition in advance and determine whether the predetermined condition is satisfied.

In an example, the predetermined condition may be set using the normal operation information and the position information. For example, the predetermined condition may be set based on whether the position detection sensor is functioning normally. In another example, the predetermined condition may be set according to whether the vehicle has entered a tunnel based on the position information. In another example, the predetermined condition may be set according to each of the two conditions described above, as well as a combination of the two conditions. The predetermined condition may be set using both whether the position detection sensor is functioning normally and whether the vehicle has entered the tunnel.

In another example, the condition determining section 110 may determine whether the predetermined condition is satisfied. For example, if it is determined that the position detection sensor is malfunctioning based on the normal operation information, the condition determining section 110 may determine that the predetermined condition is satisfied. In another example, if it is determined that the position detection sensor is determined to be functioning normally based on the normal operation information and it is determined that the vehicle has entered the tunnel based on the position information, the condition determining section 110 may determine that the predetermined condition is satisfied.

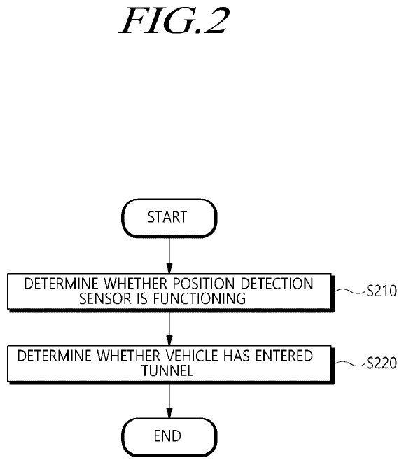

Features of this embodiment will be described below with reference to FIG. 2. In addition, the predetermined condition is set using only the position information and the normal operation information of the position detection sensor, but the predetermined condition may be set using various information without being limited to the present embodiment.

If it is determined that the predetermined condition is satisfied, the estimator 130 may produce the distance estimation information for the object candidate after the predetermined time based on the first sensing information.

For example, the estimator 130 may correct the vehicle speed information of the vehicle received from a wheel sensor using a pre-calculated error value to produce corrected vehicle speed information.

In an example, the wheel sensor is a sensor mounted on a vehicle to measure the vehicle speed. The vehicle speed information received from the wheel sensor may differ from the actual vehicle speed. However, the vehicle speed information of the vehicle must be accurately calculated so that the object recognition apparatus 100 of the present disclosure may accurately recognize and categorize objects. Therefore, the vehicle speed information received from the wheel sensor needs to be corrected using the pre-calculated error value.

In another example, the pre-calculated error value may be calculated by calculating the difference between the vehicle speed information received from the wheel sensor and the actual vehicle speed and using the ratio of the difference (i.e., air-speed error). The vehicle speed information of the vehicle may be corrected using the pre-calculated error value. By this process, the estimator 130 may correct the vehicle speed information of the vehicle using the pre-calculated error value to produce the corrected vehicle speed information.

The operation of correcting the vehicle speed information using the air-speed error and the pre-calculated error value described above may be configured in various manners. For example, the air-speed error value may be calculated and the operation of correcting the vehicle speed information may be performed according to an air-speed error calculation method and a method of correcting the vehicle speed information described in “Methods and Systems for Determining Alignment Parameters of a Radar Sensor (APTIV TECHNOLOGIES LIMITED, US, 2021-0341599 A1, 2021.11.04)”. In addition, various other air-speed error calculation methods and operations of correcting vehicle speed information known in the art may be used in the present disclosure.

In another example, the distance estimation information may be calculated using the corrected vehicle speed information and the distance information, the angle information, and the speed information for the object candidate included in the first sensing information. A detailed description of each of the factors used to calculate the distance estimation information will be described later with reference to FIGS. 3A and 3B.

The calculator 140 may calculate the distance difference information using the distance information calculated for the object candidate based on the second sensing information and the distance estimation information.

The present disclosure is a technical idea for calculating a distance difference by comparing a distance estimation value for the object candidate with an actual distance value and categorizing the object candidate using the calculated distance difference to accurately recognize the object. Accordingly, the calculator 140 needs to calculate the distance difference information using the distance information calculated for the object candidate based on the second sensing information received from the radar sensor after the predetermined time and the above-described distance estimation information. A more detailed description will be provided later with reference to FIGS. 4A to 4C.

The determining section 150 may categorize the object candidate as one of a specific object or a normal object based on the distance difference information.

For example, the object recognition apparatus 100 may define various objects recognized by the radar sensor of the vehicle as object candidates. In addition, the determining section 150 of the object recognition apparatus 100 may categorize such an object candidate as a specific object or a normal object. The meaning of the specific object and the normal object will be described below.

For example, the normal object may refer to an object which does not interfere with the driving of the host vehicle and the movement of which is estimatable.

In example, examples of the normal object of the present disclosure may include tunnel walls, guardrails, and other vehicles. In addition, the normal object may refer to an object from which estimatable information (e.g., speed information, distance information, and angle information) may be calculated based on signals received from the radar sensor of the vehicle.

In another example, the specific object may refer to an object that is distinct from the normal object.

In an example, the specific object of the present disclosure may include tunnel vents. A tunnel vent may cause Doppler shift due to the rotating characteristic thereof. That is, the tunnel vent may not be an object from which estimatable information (e.g., speed information, distance information, and angle information) may be calculated based on signals received from the radar sensor of the vehicle. Therefore, tunnel vents may be included in the specific object that is the object distinct from the normal object.

However, the normal object and the specific object are not limited to this embodiment, and may include a variety of objects.

In the following, the operation of categorizing an object candidate as one of a specific object or a normal object based on the distance difference information determined by the determining section 150 will be described.

For example, the determining section 150 may compare the distance difference information with a predetermined threshold value to categorize the object candidate as one of a specific object or a normal object.

In an example, if the distance difference information is greater than the predetermined threshold value, the determining section 150 may categorize the object candidate as a specific object. In addition, if the distance difference information is less than or equal to the predetermined threshold value, the determining section 150 may categorize the object candidate as a normal object.

In another example, if the interval between the distance difference information and the predetermined threshold value increases over time, the determining section 150 may categorize the object candidate as a specific object, and if the interval between the distance difference information and the predetermined threshold value is constant over time, the determining section 150 may categorize the object candidate as a normal object.

In another example, if it is determined that the position detection sensor is functioning normally based on the normal operation information, and it is determined that the vehicle has entered the tunnel based on the position information, the determining section 150 may categorize the object candidate as one of a specific object or a normal object based on the position information and the distance difference information. The position information is information detected from the position detection sensor, and the distance difference information is information calculated from the radar sensor. The determining section 150 may more accurately categorize the object candidate surrounding the vehicle as a specific object or a normal object using the information detected and calculated from the separate sensors. In an example, the position information of the object candidate may be identical to or match the position information of the tunnel wall. In this case, the determining section 150 may categorize the object candidate as a normal object (e.g., the tunnel wall) using the distance difference information and the position information of the tunnel wall.

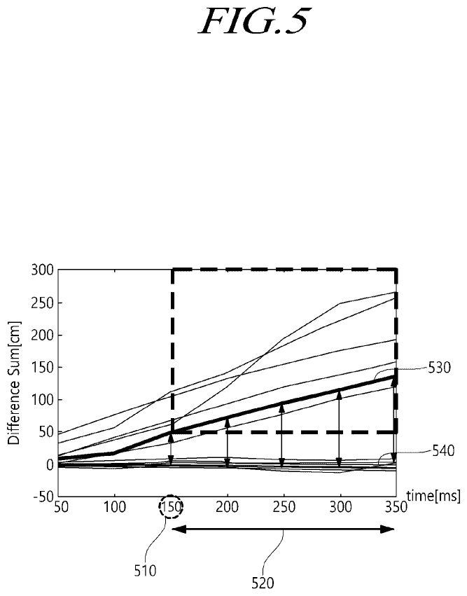

In another example, the predetermined threshold value may be set variably according to a predetermined time. The predetermined time and the predetermined threshold will be further described later with reference to FIG. 5.

The operation of categorizing the object candidate as one of a specific object or a normal object based on the distance difference information of the determining section 150 described above is not limited to this embodiment, and may be set as various operations.

Hereinafter, operations of the object recognition apparatus, including an operation of receiving first sensing information and second sensing information, an operation of determining whether a predetermined condition is satisfied, an operation of calculating distance estimation information, an operation of calculating distance difference information, and an operation of categorizing an object candidate, will be described separately. The respective operations may be applied independently or in combination with each other.

FIG. 2 is a flowchart illustrating the operation of determining whether a predetermined condition is satisfied according to embodiments.

An ADAS system may be mounted on a vehicle to assist in driving control. However, an object recognition operation may be required for the vehicle to properly use the ADAS system. In addition, the object recognition operation may be performed using a plurality of sensors (e.g., lidar sensors, radar sensors, wheel sensors, and the GPS) mounted on the vehicle. In addition, it is necessary for the sensors to function normally in order for the object recognition operation to be performed normally. However, it is not necessary for all of the sensors to function normally. For example, if one of the sensors of the vehicle malfunctions, the same operation may be performed by another sensor one of the sensors.

The present disclosure describes a concept in which even if one sensor (e.g., a position detection sensor) is malfunctioning during the object recognition operation, the vehicle performs the object recognition operation using only another sensor (e.g., a radar sensor). The disclosure also includes a concept in which the vehicle performs the object recognition operation using the sensors (e.g., position detection sensors and radar sensors) that are functioning normally.

Before the object recognition operation of the present disclosure is performed, an operation of determining whether the sensors of the vehicle are functioning normally may be necessary. In embodiments, the condition determining section may perform the operation to determine whether the sensors are functioning normally.

For example, the condition determining section may determine whether the position information detected from the position detection sensor and the normal operation information of the position detection sensor satisfy a predetermined condition.

In an example, the condition determining section may determine whether the position detection sensor is functioning normally based on the normal operation information of the position detection sensor in S210.

Operation S210 may be an important operation in determining whether information received from a radar sensor or information received from both a radar sensor and a position detection sensor is to be used when the vehicle performs the object recognition operation.

Thus, in operation S210, if it is determined that the position detection sensor of the vehicle is malfunctioning, data received from the radar sensor may be used.

In contrast, in operation S210, if it is determined that the position detection sensor of the vehicle is functioning normally, data received from the radar sensor and the position detection sensor may be used to further determine whether the vehicle has entered the tunnel.

In another example, the condition determining section may determine whether a vehicle has entered a tunnel based on position information in S220.

For example, if the position detection sensor of the vehicle is determined to be functioning normally, the position information of the vehicle may be received normally. In addition, the position information of the tunnel may also be received normally. In this case, the position information of the vehicle and the position information of the tunnel may be compared to each other to determine whether the vehicle has entered the tunnel.

In addition, if it is determined that the vehicle has entered the tunnel in operation S220, the object recognition apparatus may perform the operation of categorizing the object candidate using both the information received from the radar sensor and the information received from the position detection sensor by the determining section, which will be described later. For example, the object candidate may be more accurately categorized by mapping the position information for the object candidate and the distance difference information produced from the radar sensor.

However, if it is determined that the vehicle has entered the tunnel in operation S220, the object recognition apparatus may perform the operation of categorizing the object candidate using only the information received from the radar sensor in the determining section.

However, this embodiment is not intended to be limiting, and operations S210 and S220 may be performed separately, and any combinations of operations may be performed in sequences.

FIGS. 3A and 3B are diagrams illustrating a distance estimation information factor according to embodiments.

Referring to FIGS. 3A and 3B, distance estimation information may be calculated using distance information r_{fan} and r_{wall}, angle information φ_{wall}, and speed information v_{fan} and v_{wall} for object candidates included in corrected vehicle speed information vᵥₑₕ.' and first sensing information.

In addition, the object candidates may be fixed objects (e.g., a tunnel vent 310, a tunnel wall 320, and a guardrail), other vehicles, and the like. In addition, the fixed objects among the object candidates may exist at fixed positions. Accordingly, the speed information of the fixed objects among the object candidates may converge to zero in the direction of travel of the vehicle 300. However, specific objects (e.g., the tunnel vent 310) among the object candidates may cause the Doppler shift due to the rotating characteristic thereof, thereby generating speed information in the direction of travel of the vehicle 300. In the following, the factors of the distance information f_{fan} and r_{wall}, the angle information φ_{wall}, and the speed information r_{fan} and v_{wall} for the object candidates of the distance estimation information will be described with reference to the Doppler phenomenon.

In addition, the object candidates have been categorized and described as specific objects and normal objects. However, the operation categorizing the object candidates is performed by the determining section. Hereinafter, for case of explanation, the object candidates will be described as categorized as the specific object 310 and the normal object 320.

FIG. 3A is a side view illustration of the operation of the receiver of the vehicle 300.

For example, v_{veh.}may refer to vehicle speed information received from the wheel sensor of the vehicle 300. In addition, v_{veh.}' may refer to vehicle speed information that has been corrected using a pre-calculated error value.

In another example, f_{fan} may refer to distance information from the radar sensor of the vehicle 300 to a specific object (e.g., the tunnel vent) 310 among the object candidates.

In another example, r_{fan} may refer to distance information from the radar sensor of the vehicle 300 to a specific object (e.g., the tunnel vent) 310 among the object candidates.

FIG. 3B is a top view illustration of the operation of the receiver of the vehicle 300.

The radar sensor of the vehicle 300 may generate a sensing area 340 in the direction of travel of the vehicle. The receiver may receive the distance information r_{fan} and v_{wall} , the angle information φ_{wall} , and the speed information r_{fan} and v_{wall} for the object candidates included in first sensing information in the sensing area 340.

For example, φ_{wall} may refer to the angle information from the center 330 to a normal object (e.g., the tunnel wall) 320 among the object candidates in the direction of travel of the vehicle.

In another example, the vehicle 300 may transmit a transmission signal from the radar sensor for the specific object (e.g., the tunnel vent) 310 among the object candidates. In this case, the transmission signal may be reflected by the particular rotating object 310, thereby causing a Doppler shift. In this case, r_{fan} is the speed information distorted from the specific object 310, which may be generated in the direction of travel of the vehicle 300.

In another example, v_{wall} may refer to the speed information generated when the transmission signal from the radar sensor of the vehicle is reflected from the normal object 320 among the object candidates.

In this embodiment, only the first sensing information and the corrected vehicle speed information are described to calculate the distance estimation information.

However, second sensing information may also be received in the sensing area 340, and the second sensing information may include the distance information, the angle information, and the speed information for the object candidate received after a predetermined time, unlike the first sensing information.

In addition, the distance information r_{fan} and v_{wall} , the angle information φ_{wall} , and the speed information r_{fan} and v_{wall} for the object candidates included in the first sensing information described may be received in various manners without being limited to this embodiment, and may be predefined in various manners.

In the following description, for case of explanation, the following definitions of the distance information r_{fan} and v_{wall} , the angle information φ_{wall} , and the speed information r_{fan} and v_{wall} for the object candidate included in the corrected vehicle speed information v_{veh.}' and the first sensing information will be used.

FIGS. 4A to 4C are diagrams illustrating the operation of calculating distance difference information according to embodiments.

In principle, the operation of categorizing object candidates is performed by the determining section. For ease of explanation, the object candidates are categorized and described as a specific object 410, 411, and 412 and a normal object 420.

For example, the distance estimation information 435 may be calculated based on the first sensing information after a predetermined time Δt for object candidates.

FIG. 4A illustrates a situation in which a vehicle 300 is traveling with corrected vehicle speed information v_{veh.}' toward the object candidate 410 and 420 at a particular time t. This relates to the first sensing information.

r_{f,t}·cos(φ_{f,t}) 431 may refer to distance information from the vehicle 300 to a specific object 410. r_{w,t}·cos(φ_{w,t}) 432 may refer to distance information from the vehicle 300 to a normal object 420.

r_{f,t} may refer to distance information for the object candidate (i.e., the specific object (e.g., a tunnel vent) 410 received at the particular time t.

r_{w,t} may refer to distance information for the object candidate (i.e., the normal object (e.g., a tunnel wall) 420 received at the particular time t.

v_{veh.}' may refer to corrected vehicle speed information.

φ_{f,t} may refer to angle information for the object candidate (i.e., the specific object (e.g., the tunnel vent) 410) received at the particular time t. That is, φ_{f,t} may indicate the angle information to the specific object (e.g., the tunnel vent) 410 among the object candidates based on the direction of travel of the vehicle 300 at the particular time t.

φ_{w,t} may refer to angle information to the object candidate (i.e., the normal object (e.g., a tunnel wall surface) 420 received at the particular time t. That is, φ_{w,t} may indicate the angle information on the angle to the normal object (e.g., the tunnel wall surface) 420 among the object candidates based on the direction of travel of the vehicle 300 at the particular time t.

FIG. 4B illustrates a situation where, at a time (t) after a predetermined time Δt has passed from a given time (t), the vehicle 301 is traveling with corrected vehicle speed information v_{veh.}' directed toward the object candidates 411 and 420 at a time t+Δt. That is, this relates to the secondary sensing information.

r_{f,t+Δt}·cos(φ_{f,t+Δt}) 433 may refer to distance information from the vehicle 301 to the specific object 411. That is, r_{f,t+Δt}·cos(φ_{f,t+Δt}) 433 may refer to distance information calculated for the object candidate (i.e., the specific object) 411 based on the second sensing information. r_{w}_{ₙ}_{t+Δt}·cos(φ_{w}_{ₙ}_{t+Δt}) 434 may refer to the distance information from the vehicle 300 to the normal object 420. That is, r_{w}_{ₙ}_{t+Δt}·cos(φ_{w}_{ₙ}_{t+Δt}) 434 may refer to the distance information calculated for the object candidate (i.e., the normal object) 420 based on the second sensing information.

In principle, both the specific object 411 and the normal object 420 are at a fixed location. The first difference may refer to the distance that may occur in a case where the vehicle 300 has traveled to the same position as the vehicle 301 after Δt has passed. That is, the first difference may refer to the distance difference calculated by comparing the distance information 433 calculated for the object candidate based on the second sensing information with the distance information 431 calculated for the object candidate based on the first sensing information. Thus, the first difference may be calculated as r_{f,t+Δt}·cos(φ_{f,t+Δt}) 433—r_{f,t}·cos(φ_{f,t}) 431.

In addition, the first difference may be approximately the same value as v_{veh.}'·Δt 442. The distance is calculated as the product of velocity and time, and the first difference is the difference in distance changed from the specific object 411 during Δt. Thus, since the predetermined time Δt is the same, the first difference and v_{veh.}'·Δt 442 may be defined as approximately the same value.

FIG. 4C illustrates a situation where the estimator has produced distance estimation information 435 at a particular time t.

Equation 1 is the result of calculating the distance estimation information 435. Referring to Equation 1, the distance estimation information 435 may be calculated using the corrected vehicle speed information v_{veh.}', the distance information r_{f,t}, the angle information φ_{f,t}, and the speed information v_{f,t} for the object candidate included in the first sensing information.

$${r}_{f , t} \cdot cos ( {φ}_{f , t} ) - {v}_{veh .} {}^{′} \cdot Δ t + {v}_{f , t} \cdot Δ t \qquad [ Equation 1 ]$$

v_{f,t} may refer to speed information for the object candidate (i.e., the specific object (e.g., the tunnel vent) 410) received at the particular time (t).

In this case, the second difference may refer to a distance difference calculated by comparing the distance estimation information 435 and the distance information 431 calculated for the object candidate based on the first sensing information. That is, the second difference may be calculated using the distance estimation information 435.

In other words, the second difference may be calculated as v_{veh.}'·Δt 442—v_{f,t}·Δt 441, which is the result of r_{f,t}·cos(φ_{f,t}) 431—(r_{f,t}·cos(φ_{f,t})—v_{veh.}'Δt-v_{f,t}·Δt) 435.

The distance difference information may be calculated by subtracting the second difference from the first difference.

That is, the distance difference information may be calculated as r_{f,t}·cos(φ_{f,t}) (431)—v_{veh.}'·Δt (442)—v_{f,t}·Δt (441).

FIG. 5 is a diagram illustrating the operation of categorizing an object candidate according to embodiments.

Referring to FIG. 5, a predetermined threshold value 540 may be set variously according to predetermined times 510 and 520. The horizontal axis of the graph in FIG. 5 refers to time and is denoted in milliseconds (ms), but may also be set variously, for example, in seconds(s). The vertical axis of the graph in FIG. 5 refers to distance difference and is denoted in centimeters (cm), but may be set variously, for example, in meters (m).

For example, the determining section may compare the distance difference information 530 and the predetermined threshold value 540 to categorize the object candidate as one of a specific object or a normal object.

In an example, if the distance difference information 530 is greater than the predetermined threshold value 540, the determining section may categorize the object candidate as a specific object. In addition, if the distance difference information is less than or equal to the predetermined threshold value, the determining section may categorize the object candidate as a normal object.

In this case, the predetermined threshold value 540 may be set to be 0, which is a distance difference value corresponding to the predetermined time 510 of 0.15 seconds. In addition, the distance difference information 530 may correspond to about 50 centimeters, which is a distance difference value corresponding to the predetermined time 510 of 0.15 seconds. Thus, the distance difference information 530 is about 50 centimeters, which is greater than the predetermined threshold value 540 of 0. Thus, the determining section may categorize the object candidate as a specific object. This allows the determining section of the present disclosure to quickly categorize the object candidate as a specific object or a normal object in a short time of 0.15 seconds.

In addition, although not shown, the distance difference information may correspond to a distance difference value of about 0 cm corresponding to the predetermined time 510 of 0.15 seconds. In this case, the distance difference information may correspond to a predetermined threshold value 540 of 0 or less. Thus, the determining section may categorize the object candidate as a normal object.

In another example, if the interval between the distance difference information and the predetermined threshold value increases over time, the determining section may categorize the object candidate as a specific object. If the interval between the distance difference information and the predetermined threshold value is constant over time, the determining section may categorize the object candidate as a normal object.

In this case, the predetermined threshold value 540 may be set to be about 0, which is a distance difference value corresponding to a range of 0.15 seconds to 0.35 seconds of the predetermined time 520. In addition, the distance difference information 530 may correspond to a distance difference value of about 50 centimeters to about 120 centimeters, which corresponds to the range of 0.15 seconds to 0.35 seconds of the predetermined time 520. The determining section may calculate an interval of the distance difference information 530 and the predetermined threshold value 540 corresponding to the interval of the predetermined time 520 of 0.15 seconds to 0.35 seconds. In this case, the interval of the distance difference information 530 and the predetermined threshold value 540 corresponding to the range of 0.15 seconds to 0.35 seconds of the predetermined time 520 is increased from about 50 centimeters to about 120 centimeters. Thus, the determining section may categorize the object candidate as a specific object using the interval.

In addition, although not shown, the distance difference information may correspond to a distance difference value of about 0 cm in the range of 0.15 seconds to 0.35 seconds of the predetermined time 520. In this case, the predetermined threshold value 540 and the distance difference information may be constant in the range of 0.15 seconds to 0.35 seconds of the predetermined time 520. Thus, the determining section may categorize the object candidate as a normal object.

However, this embodiment is not intended to be limiting, and the determining section may categorize the object candidate as a normal object or a specific object in various manners.

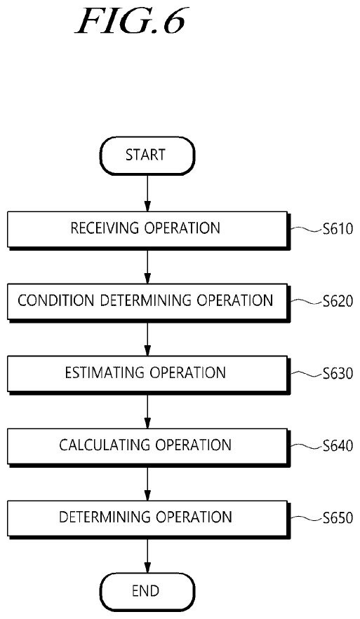

FIG. 6 is a flowchart illustrating an object recognition method according to embodiments.

Referring to FIG. 6, the object recognition method may include: a receiving operation S610 of receiving first sensing information and, after a predetermined time, second sensing information from a radar sensor; a condition determining operation S620 of determining whether a predetermined condition is satisfied based on position information detected from a position detection sensor and normal operation information of the position detection sensor; an estimating operation S630 of, if the predetermined condition is determined to be satisfied, calculating distance estimation information after the predetermined time for an object candidate based on the first sensing information; a calculation operation S640 of calculating distance difference information using distance information calculated for the object candidate based on the second sensing information and the distance estimation information; and a determining operation S650 of categorizing the object candidate as one of a specific object or a normal object based on the distance difference information.

The receiving operation may receive the first sensing information and the second sensing information after the predetermined time from the radar sensor in S610.

For example, the radar sensors may include at least one of a front radar sensor mounted on the front portion of the vehicle, a rear radar sensor mounted on the rear portion of the vehicle, and a side or side-rear radar sensor mounted on each side portion of the vehicle.

In addition, the radar sensor of the present disclosure may include at least one transmitting antenna transmitting radar signals to the outside of the vehicle and at least one receiving antenna receiving reflected signals, which are radar signals reflected from one or more objects surrounding the vehicle.

In addition, the radar sensor of the present disclosure may be implemented as a frequency modulated continuous wave (FMCW) radar. However, this is illustrative only, and the present disclosure is not limited to any particular type of radar, as long as the principle of the disclosure is applicable. An FMCW radar transmits a linear frequency modulated signal and then detects the distance and speed of a target based on the frequency difference between the received reflected signal and the FMCW signal. If the radar sensor of the present disclosure is implemented as an FMCW radar, the general configuration and operation of the FMCW radar is known in the art, and specific description is omitted.

In another example, the receiving operation may set in advance a definition for “after the predetermined time”.

In an example, the receiving operation may set “after the predetermined time” to be after a time equal to a sensing period of the radar sensor (about 50 ms to 100 ms) has passed from a time point that the vehicle entered the tunnel.

In another example, “after the predetermined time” may be set in advance to be “X seconds later”, where X is a real number greater than or equal to zero. However, this embodiment is not intended to be limiting, and “after the predetermined time” may be set variously in advance.

In another example, the first sensing information and the second sensing information may respectively include distance information, angle information, and speed information for the object candidate. The first sensing information and the second sensing information may respectively refer to information (e.g., distance information, angle information, and speed information) received from a sensing area of the radar sensor.

The condition determining operation S620 may determine whether the predetermined condition is satisfied based on the position information detected from the position detection sensor and the normal operation information of the position detection sensor.

For example, the position detection sensor may refer to a sensor mounted on a vehicle. In an example, the position detection sensor may refer to a global positioning system (GPS) device. In addition, the position detection sensor may detect the position information and the normal operation information.

In an example, the position information may include the current position of the vehicle in a case in which the vehicle is traveling. The position information may also include the position of a roadway, the position of a tunnel, the position of a structure in the tunnel (e.g., a tunnel vent or a tunnel wall), the position of a guardrail, the position of a sign, the position of an overpass, the position of a train crossing, and the like. However, the position information of this embodiment is not intended to be limiting, and the position information may include various position information.

In another example, the normal operation information may include information by which the position detection sensor is determined as functioning normally and information by which the position detection sensor is determined as malfunctioning.

However, the position detection sensor of this embodiment is not intended to be limiting, and the position detection sensor may be implemented as various position detection sensors, and may include various information.

In another example, the condition determining operation may set the predetermined condition in advance and determine whether the predetermined condition is satisfied.

In an example, the predetermined condition may be set using the normal operation information and the position information. For example, the predetermined condition may be set based on whether the position detection sensor is functioning normally. In another example, the predetermined condition may be set according to whether the vehicle has entered a tunnel based on the position information. In another example, the predetermined condition may be set according to each of the two conditions described above, as well as a combination of the two conditions. The predetermined condition may be set using both whether the position detection sensor is functioning normally and whether the vehicle has entered the tunnel.

In another example, the condition determining operation may determine whether the predetermined condition is satisfied. For example, if it is determined that the position detection sensor is malfunctioning based on the normal operation information, the condition determining section 110 may determine that the predetermined condition is satisfied. In another example, if it is determined that the position detection sensor is determined to be functioning normally based on the normal operation information and if it is determined that the vehicle has entered the tunnel based on the position information, the condition determining section 110 may determine that the predetermined condition is satisfied.

In addition, the predetermined condition is set using only the position information and the normal operation information of the position detection sensor, but the predetermined condition may be set using various information without being limited to the present embodiment.

If it is determined that the predetermined condition is satisfied, the estimating operation S630 may produce the distance estimation information for the object candidate after the predetermined time based on the first sensing information.

For example, the estimating operation may correct the vehicle speed information of the vehicle received from a wheel sensor using a pre-calculated error value to produce corrected vehicle speed information.

In an example, the wheel sensor is a sensor mounted on a vehicle to measure the vehicle speed. The vehicle speed information received from the wheel sensor may differ from the actual vehicle speed. However, the vehicle speed information of the vehicle must be accurately calculated so that the object recognition method of the present disclosure may accurately recognize and categorize objects. Therefore, the vehicle speed information received from the wheel sensor needs to be corrected using the pre-calculated error value.

In another example, the pre-calculated error value may be calculated by calculating the difference between the vehicle speed information received from the wheel sensor and the actual vehicle speed and using the ratio of the difference (i.e., air-speed error). The vehicle speed information of the vehicle may be corrected using the pre-calculated error value. By this process, the estimating operation may correct the vehicle speed information of the vehicle using the pre-calculated error value to calculate the corrected vehicle speed information.

The operation of correcting the vehicle speed information using the air-speed error and the pre-calculated error value described above may be configured in various manners. For example, the air-speed error value may be calculated and the operation of correcting the vehicle speed information may be performed according to an air-speed error calculation method and a method of correcting the vehicle speed information described in “Methods and Systems for Determining Alignment Parameters of a Radar Sensor (APTIV TECHNOLOGIES LIMITED, US, 2021-0341599 A1, 2021.11.04)”. In addition, various other air-speed error calculation methods and operations of correcting vehicle speed information known in the art may be used in the present disclosure.

In another example, the distance estimation information may be produced using the corrected vehicle speed information and the distance information, the angle information, and the speed information for the object candidate included in the first sensing information.

The calculating operation S640 may calculate the distance difference information using the distance information calculated for the object candidate based on the second sensing information and the distance estimation information.

The present disclosure is a technical idea for calculating a distance difference by comparing a distance estimation value for the object candidate with an actual distance value and categorizing the object candidate using the calculated distance difference to accurately recognize the object. Accordingly, the calculating operation needs to calculate the distance difference information using the distance information calculated for the object candidate based on the second sensing information received from the radar sensor after the predetermined time and the above-described distance estimation information.

The determining operation S650 may categorize the object candidate as one of a specific object or a normal object based on the distance difference information.

The object recognition method is intended to recognize and categorize various objects while a vehicle is traveling and to prevent accidents in advance. Therefore, the object recognition method may define various objects recognized by the radar sensor of the vehicle as object candidates. In addition, the determining operation of the object recognition method may categorize the object candidate as a specific object or a normal object. The meaning of the specific object and the normal object will be described below.

For example, the normal object may refer to an object which does not interfere with the driving of the host vehicle and the movement of which is estimatable.

In example, examples of the normal object of the present disclosure may include tunnel walls, guardrails, and other vehicles. In addition, the normal object may refer to an object from which estimatable information (e.g., speed information, distance information, and angle information) may be calculated based on signals received from the radar sensor of the vehicle.

In another example, the specific object may refer to an object that is distinct from the normal object.

In an example, the specific object of the present disclosure may include tunnel vents. A tunnel vent may cause Doppler shift due to the rotating characteristic thereof. That is, the tunnel vent may not be an object from which estimatable information (e.g., speed information, distance information, and angle information) may be calculated based on signals received from the radar sensor of the vehicle. Therefore, tunnel vents may be included in the specific object that is the object distinct from the normal object.

However, the normal object and the specific object are not limited to this embodiment, and may include a variety of objects.

In the following, the operation of categorizing an object candidate as one of a specific object or a normal object based on the distance difference information determined in the determining operation will be described.

For example, the determining operation may compare the distance difference information with a predetermined threshold value to categorize the object candidate as one of a specific object or a normal object.

In an example, if the distance difference information is greater than the predetermined threshold value, the determining operation may categorize the object candidate as a specific object. In addition, if the distance difference information is less than or equal to the predetermined threshold value, the determining operation may categorize the object candidate as a normal object.

In another example, if the interval between the distance difference information and the predetermined threshold value increases over time, the determining operation may categorize the object candidate as a specific object, and if the interval between the distance difference information and the predetermined threshold value is constant over time, the determining operation may categorize the object candidate as a normal object.

In another example, if it is determined that the position detection sensor is functioning normally based on the normal operation information, and it is determined that the vehicle has entered the tunnel based on the position information, the determining operation may categorize the object candidate as one of a specific object or a normal object based on the position information and the distance difference information. The position information is information detected from the position detection sensor, and the distance difference information is information produced from the radar sensor. The determining operation may more accurately categorize the object candidate surrounding the vehicle as a specific object or a normal object using the information detected and produced from the separate sensors. In an example, the position information of the object candidate may be identical to or match the position information of the tunnel wall. In this case, the determining operation may categorize the object candidate as a normal object (e.g., the tunnel wall) using the distance difference information and the position information of the tunnel wall.

In another example, the predetermined threshold value may be set variably according to a predetermined time.

The operation of categorizing the object candidate as one of a particular object or a normal object based on the distance difference information determined in the determining operation described above is not limited to this embodiment, and may be set as various operations.

In addition, the object recognition apparatus and/or the object recognition method according to the present disclosure may be implemented by a vehicle controller.

For example, the vehicle controller may include at least one memory having computer program instructions stored therein and at least one processor executing the computer program instructions. The vehicle controller may be an electronic controller that includes a semiconductor device, such as an ECU or an MCU.

Here, the at least one processor may: receive first sensing information and, after a preset time period, second sensing information from the radar sensor; if a predetermined condition is satisfied based on position information detected from the position detection sensor and normal operation information of the position detection sensor, produce the distance estimation information after the predetermined time for an object candidate based on the first sensing information; calculate distance difference information using distance information calculated for the object candidate based on the second sensing information and the distance estimation information; and categorize the object candidate as one of a specific object or a normal object based on the distance difference information.

In addition, the at least one processor may determine that the vehicle has entered the tunnel if the position detection sensor is determined to be malfunctioning based on the normal operation information. In another example, the at least one processor may determine that the position detection sensor is functioning normally based on the normal operation information and determine that the vehicle has entered the tunnel based on the position information. If it is determined that the vehicle has entered the tunnel, the at least one processor determines that the predetermined condition is satisfied.

In addition, the at least one processor may correct the vehicle speed information received from the wheel sensor using a pre-calculated error value to calculate corrected vehicle speed information.

The at least one processor may also calculate using the corrected vehicle speed information and the distance information, the angle information, and the speed information for the object candidate included in the first sensing information.

In addition, the at least one processor may compare the distance difference information with a predetermined threshold value to categorize the object candidate as one of a specific object or a normal object.

In an example, the at least one processor may categorize the object candidate as a specific object if the distance difference information is greater than a predetermined threshold value. In another example, the at least one processor may categorize the object candidate as a normal object if the distance difference information is less than or equal to the predetermined threshold value.

In another example, if the interval between the distance difference information and the predetermined threshold value increases over time, the at least one processor may categorize the object candidate as a specific object. That is, the at least one processor may determine the object candidate as a specific object candidate if the interval between the distance difference value and the threshold value increases.

In another example, if the interval between the distance difference information and the predetermined threshold value is constant over time, the at least one processor may categorize the object candidate as a normal object.

Here, the predetermined threshold value may be set variably according to a predetermined time.

In addition, the vehicle controller may perform the operations of the object recognition apparatus and the object recognition method described above.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

1. An object recognition apparatus of a vehicle, the object recognition apparatus comprising:
a receiver receiving first sensing information and, after a predetermined time, second sensing information from a radar sensor;
a condition determining section determining whether a predetermined condition is satisfied based on position information detected by a position detection sensor and normal operation information of the position detection sensor,
an estimator, if the predetermined condition is determined to be satisfied, producing distance estimation information of an object candidate after the predetermined time based on the first sensing information;
a calculator calculating distance difference information using distance information calculated for the object candidate based on the second sensing information and the distance estimation information; and
a determining section categorizing the object candidate as one of a specific object or a normal object based on the distance difference information.

2. The object recognition apparatus of claim 1, wherein the condition determining section:
if it is determined that the position detection sensor is malfunctioning based on the normal operation information, or
if it is determined that the position detection sensor is determined to be functioning normally based on the normal operation information and it is determined that a host vehicle has entered a tunnel based on the position information,
determines that the predetermined condition is satisfied.

3. The object recognition apparatus of claim 1, wherein the estimator corrects vehicle speed information of a host vehicle received from a wheel sensor using a pre-calculated error value to produce corrected vehicle speed information.

4. The object recognition apparatus of claim 3, wherein the distance estimation information is produced using the corrected vehicle speed information and distance information, angle information, and speed information for the object candidate included in the first sensing information.

5. The object recognition apparatus of claim 1, wherein the determining section compares the distance difference information with a predetermined threshold value to categorize the object candidate as one of the specific object or the normal object.

6. The object recognition apparatus of claim 5, wherein the determining section,
if the distance difference information is greater than the predetermined threshold value, categorizes the object candidate as the specific object, and
if the distance difference information is less than or equal to the predetermined threshold value, categorizes the object candidate as the normal object.

7. The object recognition apparatus of claim 5, wherein the determining section,
if an interval between the distance difference information and the predetermined threshold value increases over time, categorizes the object candidate as the specific object, and
if the interval between the distance difference information and the predetermined threshold value is constant over time, categorize the object candidate as the normal object.

8. The object recognition apparatus of claim 5, wherein the predetermined threshold value is set variably according to a predetermined time.

9. An object recognition method comprising:
receiving first sensing information and, after a predetermined time, second sensing information from a radar sensor;
determining whether a predetermined condition is satisfied based on position information detected from a position detection sensor and normal operation information of the position detection sensor;
if the predetermined condition is determined to be satisfied, producing distance estimation information after the predetermined time for an object candidate based on the first sensing information;
calculating distance difference information using distance information calculated for the object candidate based on the second sensing information and the distance estimation information; and
categorizing the object candidate as one of a specific object or a normal object based on the distance difference information.

10. The object recognition method of claim 9, wherein the determination of whether the predetermined condition is satisfied comprises:
if it is determined that the position detection sensor is malfunctioning based on the normal operation information, or
if it is determined that the position detection sensor is functioning normally based on the normal operation information and it is determined that a host vehicle has entered a tunnel based on the position information,
determining that the predetermined condition is satisfied.

11. The object recognition method of claim 9, wherein the producing of the distance estimation information comprises correcting vehicle speed information of a host vehicle received from a wheel sensor using a pre-calculated error value to produce corrected vehicle speed information.

12. The object recognition method of claim 11, wherein the distance estimation information is calculated using the corrected vehicle speed information and distance information, angle information, and speed information for the object candidate included in the first sensing information.

13. The object recognition method of claim 9, wherein the determination of whether the predetermined condition is satisfied comprises comparing the distance difference information with a predetermined threshold value to categorize the object candidate as one of the specific object or the normal object.

14. The object recognition method of claim 13, wherein the determination of whether the predetermined condition is satisfied comprises:
if the distance difference information is greater than the predetermined threshold value, categorizing the object candidate as the specific object; and
if the distance difference information is less than or equal to the predetermined threshold value, categorizing the object candidate as the normal object.

15. The object recognition method of claim 13, wherein the determination of whether the predetermined condition is satisfied comprises:
if an interval between the distance difference information and the predetermined threshold value increases over time, categorizing the object candidate as the specific object; and
if the interval between the distance difference information and the predetermined threshold value is constant over time, categorizing the object candidate as the normal object.

16. A vehicle controller comprising:
at least one memory having computer program instructions stored therein; and
at least one processor executing the computer program instructions,
wherein the at least one processor:
receives first sensing information and, after a preset time period, second sensing information from a radar sensor;
if a predetermined condition is satisfied based on position information detected from the position detection sensor and normal operation information of the position detection sensor, produces the distance estimation information after the predetermined time for an object candidate based on the first sensing information;
calculates distance difference information using distance information calculated for the object candidate based on the second sensing information and the distance estimation information; and
categorizes the object candidate as one of a specific object or a normal object based on the distance difference information.

17. The vehicle controller of claim 16, wherein if it is determined that the position detection sensor is malfunctioning based on the normal operation information, or
if it is determined that the position detection sensor is functioning normally based on the normal operation information and it is determined that a host vehicle has entered a tunnel based on the position information,
the at least one processor determines that the predetermined condition is satisfied.

18. The vehicle controller of claim 16, wherein the at least one processor corrects vehicle speed information of a host vehicle received from a wheel sensor using a pre-calculated error value to calculate corrected vehicle speed information.

19. The vehicle controller of claim 18, wherein the distance estimation information is produced using the corrected vehicle speed information and distance information, angle information, and speed information for the object candidate included in the first sensing information.

20. The vehicle controller of claim 16, wherein the at least one processor compares the distance difference information with a predetermined threshold value to categorize the object candidate as one of the specific object or the normal object.
